(19) United States
(12) Patent Application Publication
(10) Pub. No.: US 2026/0115632 A1
(43) Pub. Date: Apr. 30, 2026

(54) FILTER CARTRIDGE FOR AQUARIUM; AND METHODS

(71) Applicant: Spectrum Brands, Inc., Middleton, WI (US)

(72) Inventor: William D. Himes, Middleton, WI (US)

(21) Appl. No.: 18/925,357

(22) Filed: Oct. 24, 2024

(51) Int. Cl. B01D 27/08; A01K 63/04; B01D 27/02; B01D 27/04; C02F 1/00; C02F 1/28; C02F 103/20

(52) U.S. Cl. CPC B01D 27/08; A01K 63/045; B01D 27/02; B01D 27/04; C02F 1/001; C02F 1/283; B01D 2101/02; B01D 2201/29; B01D 2201/4084; C02F 2103/20; C02F 2201/004

(57) ABSTRACT

A filter cartridge for an aquarium filter assembly includes a media pack and a frame supporting the media pack. The frame includes a non-clip fastener arrangement connecting the frame and the media pack.

### TECHNICAL FIELD

This disclosure relates to aquarium filter devices and methods of using such devices.

### BACKGROUND

Aquariums have long been popular for keeping and displaying fish, both fresh and saltwater varieties. However, the recreation of freshwater or saltwater environments in the self-contained systems of home aquariums has presented considerable difficulties. Initially a good water source must be obtained for the start of the aquarium. Additionally, there's the task of maintaining the water quality and dealing with waste materials either i) excreted by the aquatic specimens, ii) formed by the natural decomposition by bacteria of plant, animal tissues and food, or iii) resulting from foreign contamination of the aquarium environment. This task becomes even more important with saltwater environments, which must maintain many delicate balances including pH and salinity.

It is generally understood that in maintaining the health and vitality of the animals confined to an aquarium, provision must be made for continuous filtration and recirculation of the aquarium water. A number of differently configured aquarium filter systems have been devised in an attempt to meet this need. One such system is the external aquarium filter in which a filter housing is located outside the aquarium tank and positioned such that the aquarium water is drawn up from the aquarium and into the filter by means of external tubes or tubular extensions.

A typical external filter system consists of an electrically powered pump, intake and return lines or tubes, a filter housing containing and a filter medium such as activated charcoal overlaid with one or more layers of synthetic filter material. As water is siphoned out of the aquarium tank via an inlet tube, it moves through the filter housing inlet chamber into the central housing chamber where it passes through the filter medium into the housing outlet chamber and is pumped back into the aquarium via the return line.

Although the external filter device is generally adequate for providing mechanical filtration, external aquarium filter systems are usually large and bulky. Additionally, the presence of such additional components as intake and return lines (or tubing) tends to create bulkiness and increases the risk of clogging and/or mechanical breakdown.

Another type of aquarium filter system presently in use is the undergravel aquarium filter, specifically designed for placement within the aquarium tank. This type of system is comprised of inlet and outlet tubes, a pumping device, a means for aerating the aquarium water, and a filter housing composed of inlet and outlet chambers where the outlet chamber contains a filter medium such as activated charcoal. Water from the aquarium is pumped through the inlet tube to outlet chamber through and exits to the aquarium tank via the outlet tube.

One problem inherent in the undergravel aquarium filter concerns its size. Since such a system is dimensionally configured so as to be unobtrusive when placed within the aquarium tank, its filter housing is relatively small. Therefore, the volume of filter material contained within the housing is generally not sufficient to provide adequate mechanical filtration. Another problem with this type of system concerns the location of the filter. Because the filter is positioned underwater within the aquarium tank, the filter housing must be physically separated from the system and removed from the aquarium tank to accomplish cleaning of the filter; a procedure which disturbs the aquarium environment and interrupts the entire filtering process.

One type of useful filter system is described in commonly assigned U.S. Pat. No. 6,797,163, incorporated herein by reference. Although the filter system described in this patent is useful, improvements are always desirable.

### SUMMARY

A filter cartridge is provided that improves the prior art.

In one aspect, a filter cartridge for an aquarium filter assembly is provided. The filter cartridge comprises: a media pack; a frame supporting the media pack; and the frame including a non-clip fastener arrangement connecting the frame and the media pack.

In some example embodiments, the non-clip fastener arrangement comprises a snap fit arrangement.

In example implementations, the snap fit arrangement includes one of a cantilever, ball and socket, annular, or u-shaped snap fit.

In some arrangements, the frame comprises a top end arrangement having the non-clip fastener arrangement integral therewith.

In some example embodiments, the non-clip fastener arrangement comprises a snap fit arrangement.

In example implementations, the snap fit arrangement includes a plurality of nubs projecting from the top end arrangement received within a plurality of openings in the top end arrangement; each of the openings being sized to engage a respective one of the nubs.

In some arrangements, the frame further comprises: a pair of side rails extending from the top end arrangement; and a bottom rail extending between the side rails; the bottom rail being at an end of the frame opposite of the top end arrangement.

In some example embodiments, a first part of the frame is inside of the media pack, and a second part of the frame is outside of the media pack.

In example implementations, the media pack comprises an outer surrounding wall defining a first media wall, an opposite second media wall, and an interior volume; the first part of the frame being within the interior volume.

In some arrangements, the top end arrangement includes: a top rail extending between the side rails; the top rail having first and second opposite surfaces; a first plate covering the first surface of the top rail; a second plate covering the second surface of the top rail; and the snap fit arrangement is between: (i) the first plate and the first surface of the top rail; and (ii) the second plate and the second surface of the top rail.

In some example embodiments, the first media wall is between and against the first plate and the first surface of the top rail; and the second media wall is between and against the second plate and the second surface of the top rail.

In example implementations, the snap fit arrangement includes: a first plurality of nubs projecting from the first surface of the top rail; a second plurality of nubs projecting from the second surface of the top rail; the first plate having a plurality of openings each sized to engage a respective one of the first nubs; the second plate having a plurality of openings each sized to engage a respective one of the second nubs; and wherein the first nubs extend through the first media wall, and the second nubs extend through the second media wall.

In some arrangements, the outer surrounding wall of the media pack comprises a floss media; and the media pack further includes activated carbon within the interior volume.

In some example embodiments, the top end arrangement further includes a pull tab projecting therefrom in a direction away from a remaining part of the frame.

In example implementations, the snap fit arrangement is a non-permanent, repeatable connection.

In some arrangements, the snap fit arrangement is a one-time, permanent connection.

In some example embodiments, the top end arrangement includes a living hinge between the first plate and the top rail; and between the second plate and the top rail.

In example implementations, the frame further includes a bar extending between the side rails and being spaced from both the top end arrangement and bottom rail.

In another aspect, a method of assembling a filter cartridge is provided. The method comprises: providing a media pack having an outer surrounding wall defining a first media wall, an opposite second media wall, and an interior volume; inserting a portion of a frame into the interior volume; folding a first plate of the frame to trap the first media wall between and against the first plate and a top rail of the frame; snapping the first plate to the top rail with the first media wall therebetween; folding a second plate of the frame to trap the second media wall between and against the second plate and the top rail; and snapping the second plate to the top rail with the second media wall therebetween.

In some example methods, the step of snapping the first plate to the top rail includes using first nubs projecting from the top rail to engage openings in the first plate; and wherein snapping the second plate to the top rail includes using second nubs projecting from the top rail to engage openings in the second plate.

Some example methods further include, after the step of inserting the frame into the interior volume, putting activated carbon into the interior volume.

The present technology may be more completely understood and appreciated in consideration of the following detailed description of various embodiments in connection with the accompanying drawings.

### BRIEF DESCRIPTION OF THE DRAWINGS

FIG. 1 is a schematic, perspective view of an aquarium having a filter assembly, the filter assembly including a filter cartridge, constructed in accordance with principles of this disclosure;

FIG. 2 is front view of the filter cartridge used with the filter assembly of FIG. 1;

FIG. 3 is a top view of the filter cartridge of FIG. 2;

FIG. 4 is a side view of the filter cartridge of FIG. 2;

FIG. 5 is a cross-sectional view of the filter assembly of FIG. 1;

FIG. 6 is a perspective view showing one step of making the filter cartridge of FIGS. 2-4;

FIG. 7 is a front view showing another step of making the filter cartridge of FIGS. 2-4;

FIG. 8 is a perspective view of a frame used in the filter cartridge of FIGS. 2-4;

FIG. 9 is another perspective view of a frame used in the filter cartridge of FIGS. 2-4;

FIG. 10 is a front view of the frame of FIG. 8;

FIG. 11 is an enlarged view of a portion of the frame of FIG. 10;

FIG. 12 is a side view of a portion of the frame of FIG. 8;

FIG. 13 is an enlarged perspective view of the frame of FIG. 8; and

FIG. 14 is a top view of the frame of FIG. 8.

### DETAILED DESCRIPTION

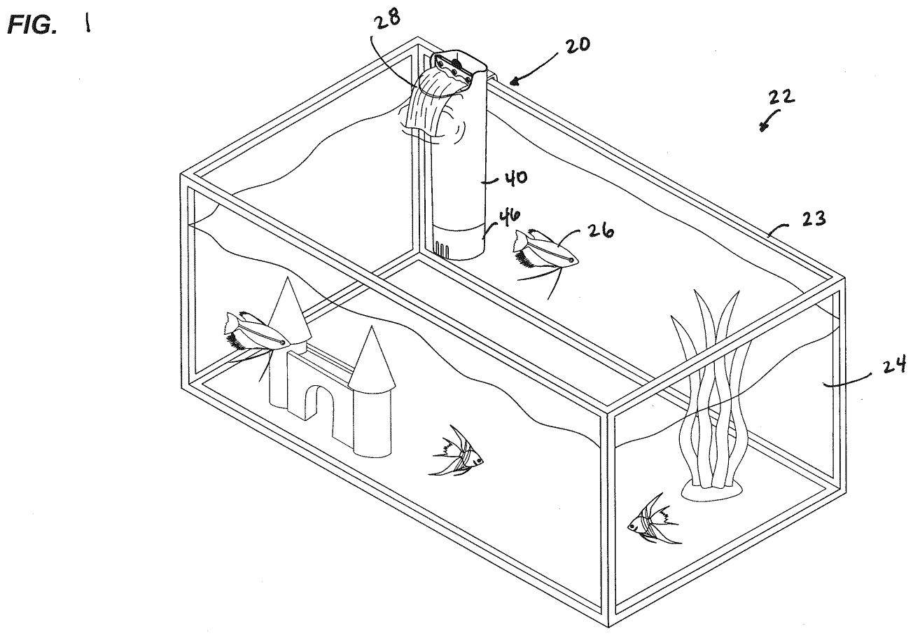

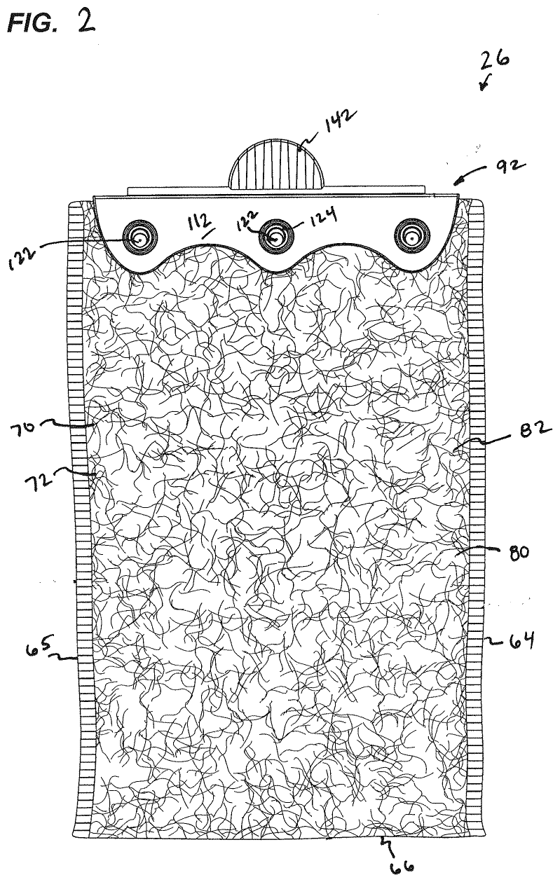

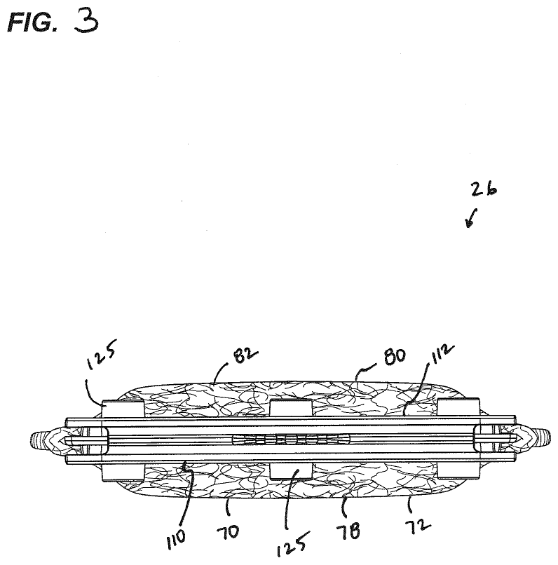

FIG. 1 schematically illustrates a filter assembly 20 used with an aquarium 22. The aquarium 22 includes a tank 23 having a surrounding wall 24 holding water for sustaining aquatic life, such as fish 26, etc. The filter assembly 20 is mounted on the wall 24. The filter assembly 20 takes in water from the tank 23, passes it through a filter cartridge 26 (FIGS. 2-5) to clean the water of particulate and impurities, and then returns to the cleaned (filtered) water to the tank 23. In this implementation, the cleaned water pours over a top of the filter assembly 20 to form a waterfall 28. In this way, the cleaned water is aerated before being returned to the tank 23. The filter cartridge 26 is removeable from and replaceable in the filter assembly 20.

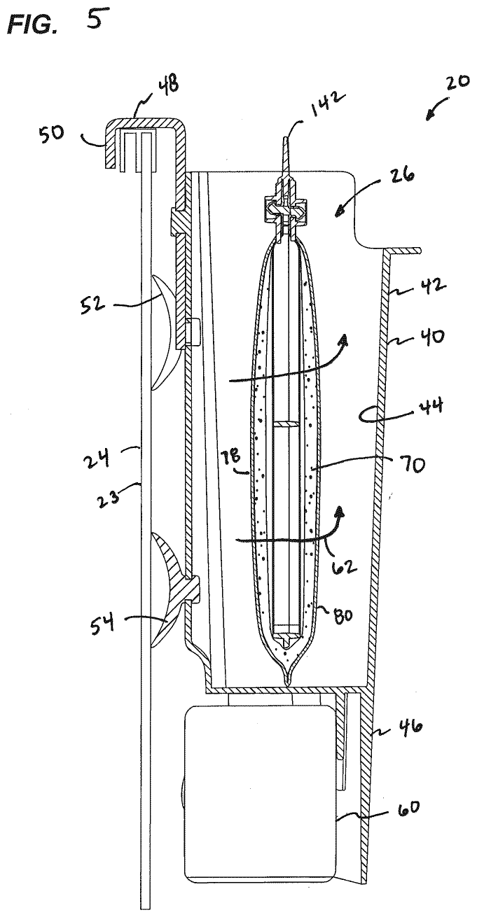

Referring now to FIG. 5, the filter assembly 20 comprises an outer housing 40, having an upper section 42 which forms a filter chamber 44 and a lower section 46 which extends beyond the lower boundary of filter chamber 44. The housing 40 is, preferably, in the form of a cylindrical or substantially cylindrical container having a latitudinal cross-section of curvilinear shape, preferably a latitudinal cross-section of elliptical or oval shape. In the described embodiment, the filtration device is supported on the wall 24 of the tank 23 by an adjustable hanging mechanism 48. The hanging mechanism 48 can take the form of a hook 50 and/or, optionally, suction cup 52. Additional support can by provided by, optionally, incorporating at least one other suction cup 54.

Water from the tank 23 is brought into the filter assembly 20 using flow pump 60. The flow pump 60 is positioned in fluid flow communication with filter chamber 44 and, preferably, shielded by lower section 46.

When the flow pump 60 is operating, aquarium water is drawn from the aquarium tank 23 and into the flow pump 60. The water drawn into the flow pump 60 passes by an impeller within the pump, through an outflow port and into mechanical filtration chamber 44.

Contained within the mechanical filtration chamber 44 is the filter cartridge 26. Filtration is performed as the aquarium water flows directionally at arrow 62 through the filter cartridge 26 as illustrated in FIG. 5.

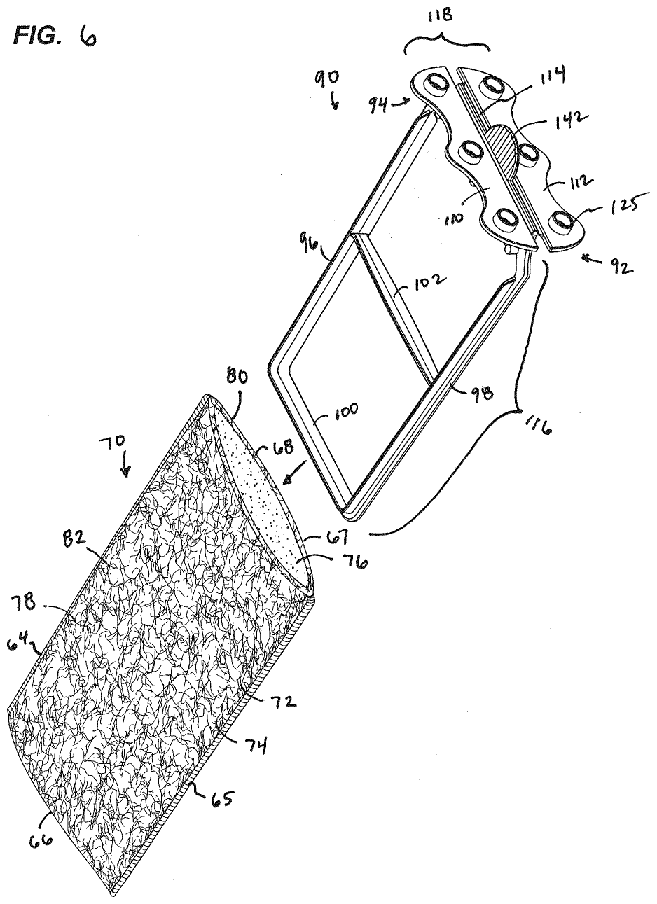

The filter cartridge 26 includes a media pack 70. The media pack 70 can be a variety of materials. In this example, the media pack 70 includes an outer surrounding wall 72 forming an envelope 74 (FIG. 6) and defining an interior volume 76 (FIG. 7). The envelope 74 has a first media wall 78, an opposite second media wall 80, and the interior volume 76 therebetween. While many variations are possible, in the example shown in the drawings, the media pack 70 is rectangular in shape having opposite straight side edges 64, 65, joined by a straight bottom edge 66. The side edges 64, 65 may be fused together to create seams, while the bottom edge 66 can be a fold line. Many variations are possible. Opposite of the bottom edge 66 and extending between the side edges 64, 65 is a top edge 67 (FIGS. 6 and 7). The top edge 67 is defined by the terminal ends of the first media wall 78 and second media wall 80. Before being closed by a frame 90 (described below), it defines an open mouth 68 (FIG. 6) which is in communication with the interior volume 76. In the example shown, the top edge 67 is straight, but many variations are possible.

The outer surrounding wall 72, in this example embodiment, comprises a floss media 82. The floss media 82 can be made from non-woven synthetic resin fibers. It is believed that the resin fibers, in view of their large surface area, provide a medium for biological filtration by creating an environment conducive for bacterial growth. In an aquarium, biological filtration can be helpful to rid the tank of (or nitrify) toxic ammonia. Within the interior volume 76 of the envelope 74 can be a material for further chemical or mechanical filtration, such as granular activated carbon or carbon black 84 (FIG. 7). The activated carbon 84 removes certain chemicals in the water by trapping/adsorbing the chemicals.

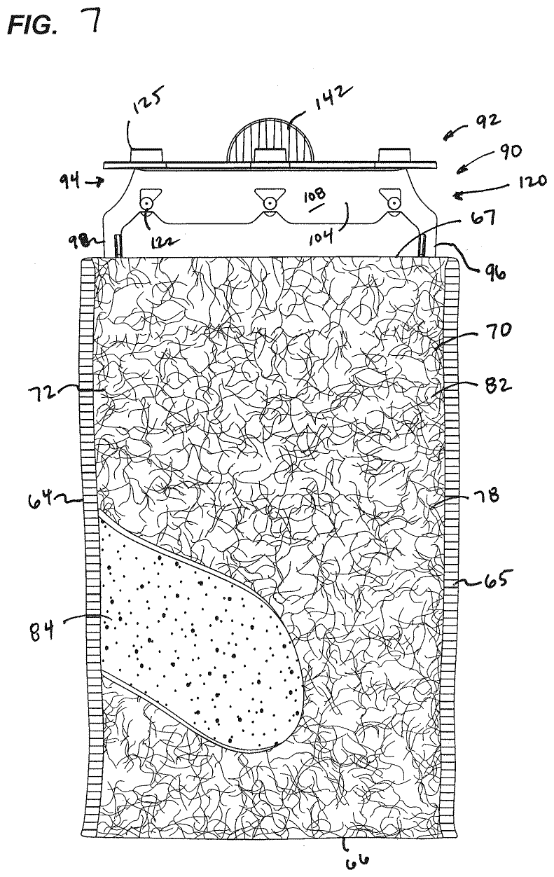

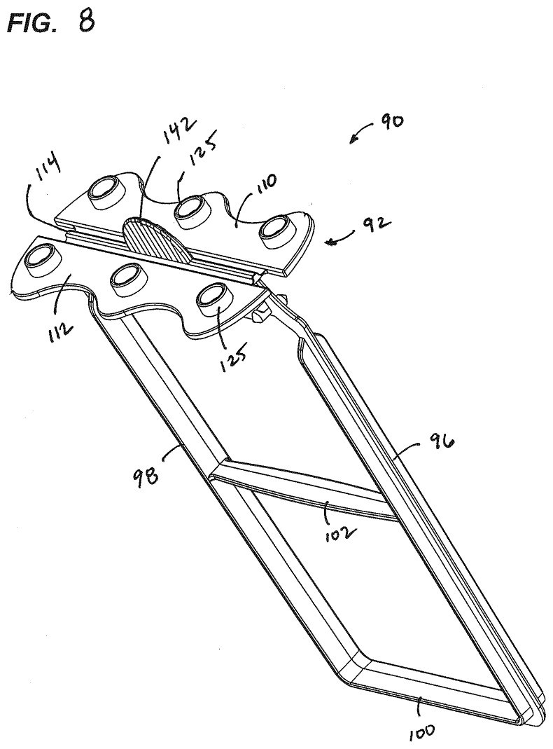

In reference now to FIGS. 8-10, the filter cartridge 26 further includes frame 90. The frame 90 supports the media pack 70 (see FIGS. 6 and 7). The frame 90 includes a non-clip fastener arrangement 92 connecting the frame 90 and the media pack 70.

The frame 90 can be a variety of constructions. In this example, the frame 90 comprises a top end arrangement 94 having the non-clip fastener arrangement 92 integral therewith. By the term “integral”, it is meant that it is non-removable and preferably made out of the same piece of material - when molded, it is molded as a single piece.

The frame 90 further includes a pair of side rails 96, 98 extending from the top end arrangement 94, with the top end arrangement 94 extending therebetween. In example embodiments, the side rails 96, 98 can be parallel or may be slightly (i.e., less than 5°) diverging toward each other, as they extend away from the top end arrangement 94. A bottom rail 100 extends between the side rails 96, 98. The bottom rail 100, in the example embodiment shown, is at an end of the frame 90 opposite of the top end arrangement 94. An optional bar 102 extends between the side rails 96, 98 and is spaced from both the top end arrangement 94 and bottom rail 100. In the non-limiting example shown, the bar 102 is located within about 10% of the midway point between the top end arrangement 94 and bottom rail 100.

In FIG. 6, it can be appreciated that the frame 90 includes a first part 116, which is positioned inside of the media pack 70, and a second part 118 which is positioned outside of the media pack 70. The first part 116 of the frame 90 is within the interior volume 76. FIG. 7 illustrates the frame 90 partially inserted through the mouth 68 (FIG. 6) and into the interior volume 76.

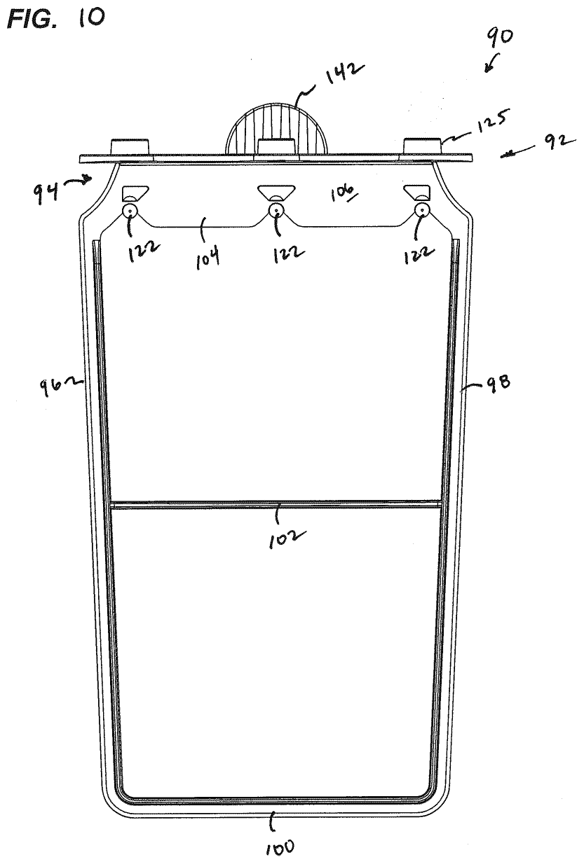

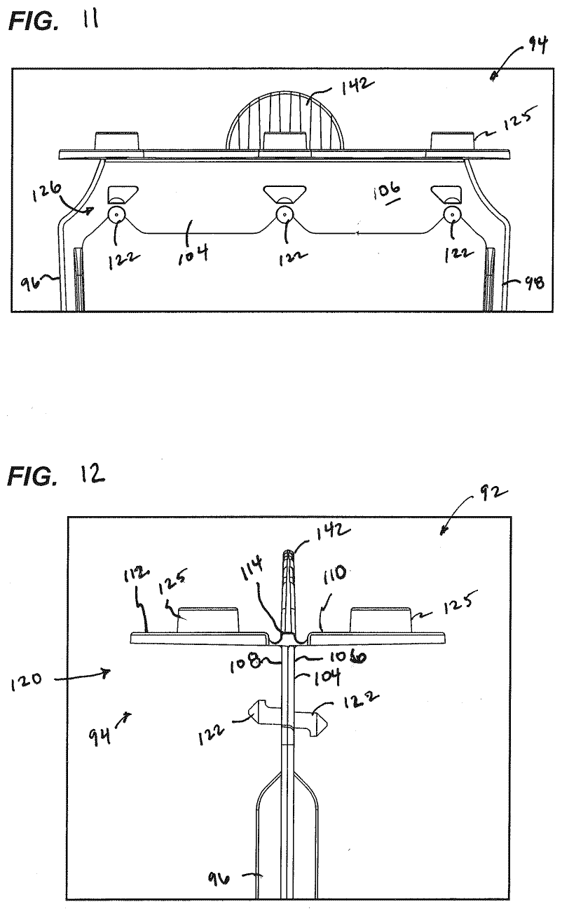

In reference now to FIGS. 11-13, an example embodiment of the top end arrangement 94 is shown in further detail. In this example embodiment, the top end arrangement 94 includes a top rail 104 extending between the side rails 96, 98. The top rail 104 has a first surface 106 and an opposite second surface 108 (FIG. 12). The top end arrangement 94 further includes a first plate 110 and a second plate 112. The first plate 110 and second plate 112, before final assembly, extend at a perpendicular angle from the top rail 104. During assembly, the first plate 110 is moved in a direction toward the first surface 106 to cover the first surface 106 of the top rail 104. The second plate 112 is moved in a direction toward the second surface 108 of the top rail 104. In preferred implementations, a living hinge 114 is between the first plate 110 and the top rail 104, and between the second plate 112 and the top rail 104 to allow the first plate 110 and second plate 112 to be moved or folded in a direction toward the top rail 104.

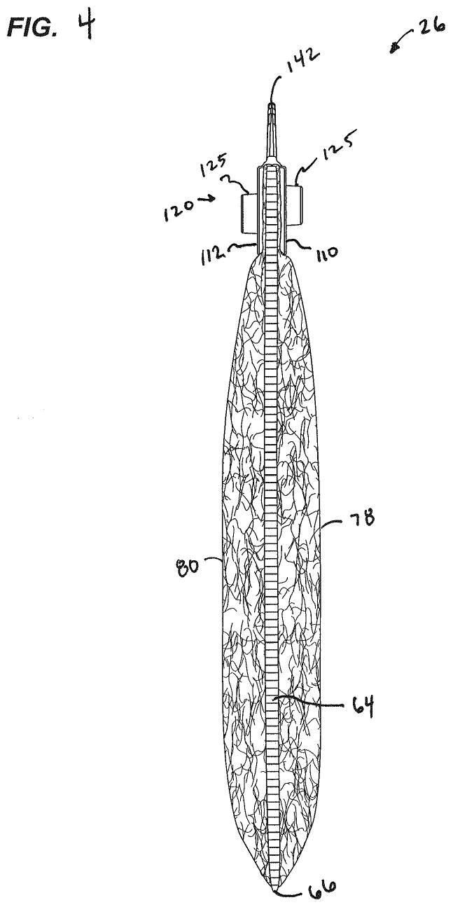

The non-clip fastener arrangement 92 can have many implementations. In example embodiments, the non-clip fastener arrangement 92 comprises a snap fit arrangement 120. In FIGS. 4, 6, and 12, it can be appreciated that the snap fit arrangement 120 is between: (i) the first plate 110 and the first surface 106 of the top rail 104; and (ii) the second plate 112 and the second surface 108 of the top rail 104.

There can be many implementations of snap fit arrangements 120. For example, the snap fit arrangement 120 can includes one of: a cantilever, ball and socket, annular, or u-shaped snap fit arrangement 120. The snap fit arrangement 120 can be a non-permanent, repeatable connection; or alternatively, the snap fit arrangement 120 can be a one-time, permanent connection.

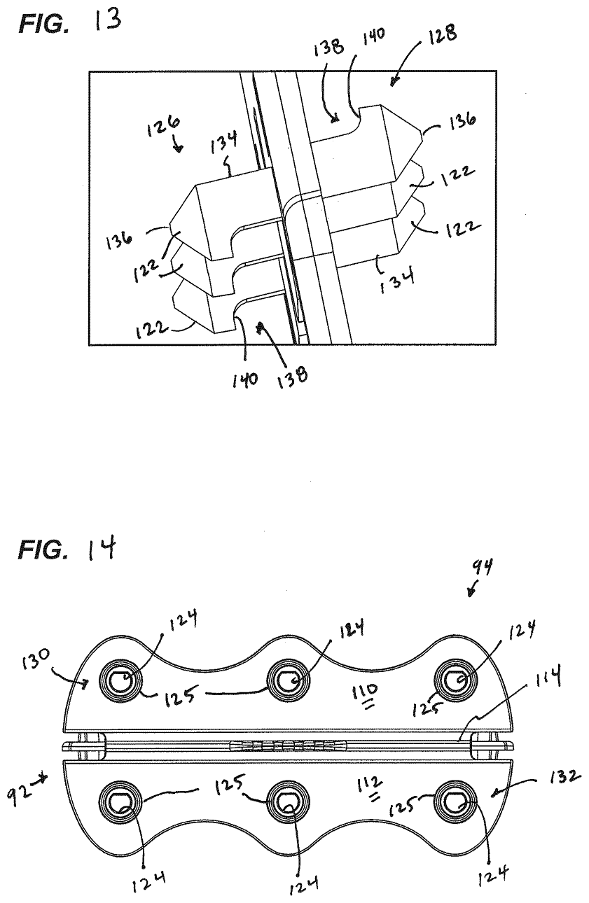

In the example embodiment shown, the snap fit arrangement 120 includes a plurality of nubs 122 (FIGS. 12 and 14) projecting from the top end arrangement 94 received within a plurality of openings 124 (FIG. 13) in the top end arrangement 94. Each of the openings 124 are sized to engage a respective one of the nubs 122. The nubs 122 are projections or protrusions shaped to engage a mating part to result in a connection. The connection is preferably a snap fit. Each opening 124 is surrounded by a projecting ring/boss 125.

In the example embodiment shown, a first plurality 126 of the nubs 122 project from the first surface 106 of the top rail 104. A second plurality 128 of nubs 122 project from the second surface 108 of the top rail 104. The first plate 110 has a first plurality 130 of openings 124 each sized to engage a respective one of the first plurality 126 of nubs 122. The second plate 112 has a second plurality 132 of openings 124 each sized to engage a respective one of the second plurality 128 of nubs 122. In FIGS. 2-4, it can be seen how the first plurality 126 of nubs 122 extends through the first media wall 78, and the second plurality 128 of nubs 122 extends through the second media wall 80.

Many embodiments of the nubs 122 are possible. In the example shown, and in reference to FIG. 13, each nub 122 has a post 134 and a free end 136. Preferably, the free end 136 is conically shaped to help it extend through the media walls 78, 80, but could be other shapes. Each post 134 includes a recess 138 to define a catch 140. The recess 138 and catch 140 help each nub 122 to engage and “snap fit” with a respective opening 124. In FIGS. 12 and 13, it can be seen how, in this embodiment, the recesses 138 in the first plurality 126 of nubs 122 and the recesses 138 in the second plurality 132 of nubs 122 are directed in opposite directions from each other. Specifically, the recesses 138 in the first plurality 126 of nubs 122 point downward toward the bottom rail 100, while the second plurality 132 of nubs 122 point upward away from the bottom rail 100.

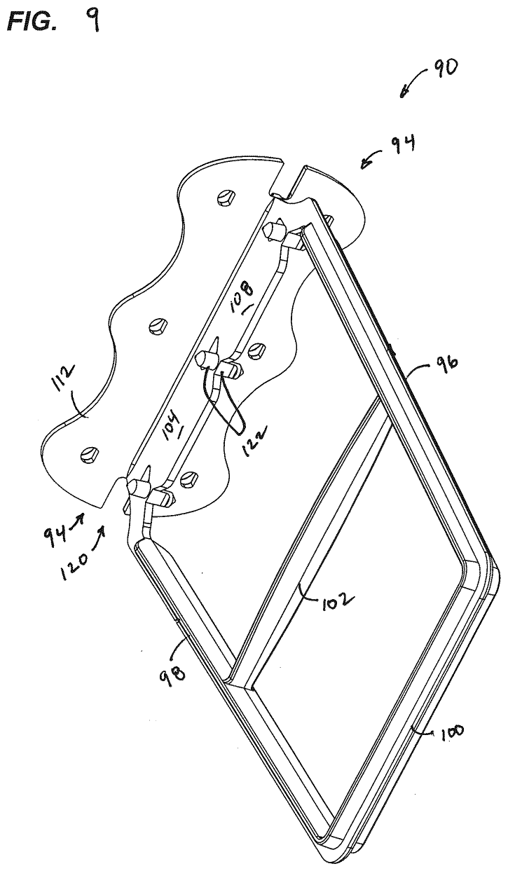

In reference to FIG. 10, the top end arrangement 94 further includes a pull tab 142 projecting therefrom in a direction away from a remaining part of the frame 90. The pull tab 142 is provided as a handle to assist the user in placing and removing the cartridge 26 from the filter assembly 20. The pull tab 142 is shown as centered between the side rails 96, 98 and projects from between the first plate 110 and second plate 112. Many different shapes are possible. In the example shown, the pull tab 142 is semi-circle shaped and as such, is eye-catching and attractive. Again, other shapes can be used, as well.

In reference now to FIGS. 6, 7, and 2-4, a method of assembling the filter cartridge 26 is provided. The method includes providing the media pack 70. The media pack 70 has outer surrounding wall 72 defining first media wall 78, opposite second media wall 80, and interior volume 76. Next, the method includes inserting a portion (first part 116) of frame 90 into the interior volume 76. See FIGS. 6 and 7. Next, the method includes folding first plate 110 of the frame 90 to trap the first media wall 78 between and against the first plate 110 and top rail 104 of the frame 90. Next, the method includes snapping the first plate 110 to the top rail 104 with the first media wall 78 therebetween. See FIGS. 2-4. Next, the method includes folding the second plate 112 of the frame 90 to trap the second media wall 80 between and against the second plate 112 and the top rail 104. Next, the method includes snapping the second plate 112 to the top rail 104 with the second media wall 80 therebetween.

Preferably, the step of snapping the first plate 110 to the top rail 104 includes using first nubs 126 projecting from the top rail 104 to engage openings 124 in the first plate 110. The step of snapping the second plate 112 to the top rail 104 includes using second nubs 128 projecting from the top rail 104 to engage openings 124 in the second plate 112.

In reference to FIG. 6, the method further includes, after the step of inserting the frame 90 into the interior volume 76, putting activated carbon 84 into the interior volume 76.

The snap fit can be repeatable, such that the frame 90 is reusable. In the case, when the filter cartridge 26 is replaced, the original media pack 70 is disposed of and replaced. In example embodiments, this would mean disposing of the original floss media 82 and activated carbon 84. A new media pack 70 is provided, including new floss media 82 and new activated carbon 84.

Alternatively, the entire cartridge 26 can be disposed of and replaced. In that case, the snap fit can be made to be a one-time, non-repeatable connection.

The above is example principles. Many embodiments can be made using these principles.

What is claimed is:

1. A filter cartridge for an aquarium filter assembly; the filter cartridge comprising:
(a) a media pack;
(b) a frame supporting the media pack; and
wherein the frame includes a non-clip fastener arrangement connecting the frame and the media pack.

2. The filter cartridge of claim 1, wherein the non-clip fastener arrangement comprises a snap fit arrangement.

3. The filter cartridge of claim 2, wherein the snap fit arrangement includes one of a cantilever, ball and socket, annular, or u-shaped snap fit.

4. The filter cartridge of claim 1 wherein the frame comprises a top end arrangement having the non-clip fastener arrangement integral therewith.

5. The filter cartridge of claim 4, wherein the non-clip fastener arrangement comprises a snap fit arrangement.

6. The filter cartridge of claim 5, wherein the snap fit arrangement includes a plurality of nubs projecting from the top end arrangement received within a plurality of openings in the top end arrangement; each of the openings being sized to engage a respective one of the nubs.

7. The filter cartridge of claim 5, wherein the frame further comprises:
(a) a pair of side rails extending from the top end arrangement; and
(b) a bottom rail extending between the side rails; the bottom rail being at an end of the frame opposite of the top end arrangement.

8. The filter cartridge of claim 5, wherein a first part of the frame is inside of the media pack, and a second part of the frame is outside of the media pack.

9. The filter cartridge of claim 8, wherein the media pack comprises an outer surrounding wall defining a first media wall, an opposite second media wall, and an interior volume; the first part of the frame being within the interior volume.

10. The filter cartridge of claim 9, wherein the top end arrangement includes:
(a) a top rail extending between the side rails; the top rail having first and second opposite surfaces;
(b) a first plate covering the first surface of the top rail;
(c) a second plate covering the second surface of the top rail; and
(d) the snap fit arrangement is between: (i) the first plate and the first surface of the top rail; and (ii) the second plate and the second surface of the top rail.

11. The filter cartridge of claim 10, wherein:
(a) the first media wall is between and against the first plate and the first surface of the top rail;
(b) the second media wall is between and against the second plate and the second surface of the top rail.

12. The filter cartridge of claim 11, wherein the snap fit arrangement includes:
(a) a first plurality of nubs projecting from the first surface of the top rail;
(b) a second plurality of nubs projecting from the second surface of the top rail;
(c) the first plate having a plurality of openings each sized to engage a respective one of the first nubs;
(d) the second plate having a plurality of openings each sized to engage a respective one of the second nubs; and
wherein the first nubs extend through the first media wall, and the second nubs extend through the second media wall.

13. The filter cartridge of claim 12, wherein:
(a) the outer surrounding wall of the media pack comprises a floss media; and
(b) the media pack further includes activated carbon within the interior volume.

14. The filter cartridge of claim 10, wherein the top end arrangement further includes a pull tab projecting therefrom in a direction away from a remaining part of the frame.

15. The filter cartridge of claim 5, wherein the snap fit arrangement is a non-permanent, repeatable connection.

16. The filter cartridge of claim 5, wherein the snap fit arrangement is a one-time, permanent connection.

17. The filter cartridge of claim 10, wherein the top end arrangement includes a living hinge between the first plate and the top rail; and between the second plate and the top rail.

18. The filter cartridge of claim 7, wherein the frame further includes a bar extending between the side rails and being spaced from both the top end arrangement and bottom rail.

19. A method of assembling a filter cartridge; the method comprising:
(a) providing a media pack having an outer surrounding wall defining a first media wall, an opposite second media wall, and an interior volume;
(b) inserting a portion of a frame into the interior volume;
(c) folding a first plate of the frame to trap the first media wall between and against the first plate and a top rail of the frame;
(d) snapping the first plate to the top rail with the first media wall therebetween;
(e) folding a second plate of the frame to trap the second media wall between and against the second plate and the top rail; and
(f) snapping the second plate to the top rail with the second media wall therebetween.

20. The method of claim 19, wherein snapping the first plate to the top rail includes using first nubs projecting from the top rail to engage openings in the first plate; and wherein snapping the second plate to the top rail includes using second nubs projecting from the top rail to engage openings in the second plate.

21. The method of claim 19, further including, after the step of inserting the frame into the interior volume, putting activated carbon into the interior volume.
